(19) United States
(12) Patent Application Publication
(10) Pub. No.: US 2026/0312115 A1
(43) Pub. Date: Oct. 8, 2026

(54) SECONDARY BATTERY

(71) Applicant: SAMSUNG SDI CO., LTD., Yongin-si (KR)

(72) Inventors: Kyung Geun KIM, Yongin-si (KR); Yeon Bok JEONG, Yongin-si (KR)

(21) Appl. No.: 19/300,936

(22) Filed: Aug. 15, 2025

(30) Foreign Application Priority Data
Apr. 2, 2025 (KR) 10-2025-0042642

(51) Int. Cl. H01M 10/04; H01M 50/105; H01M 50/249; H01M 50/553

(52) U.S. Cl. CPC H01M 10/0431; H01M 10/0463; H01M 50/105; H01M 50/553; H01M 50/249; H01M 2220/20

(57) ABSTRACT

A secondary battery includes a wound electrode part includes a first electrode plate, a second electrode plate, and a separator. A plate electrode part is provided to at least one side of the wound electrode part or in a core of the wound electrode part. The plate-shaped electrode part includes a plate-shaped electrode plate.

### CROSS-REFERENCE TO THE RELATED APPLICATION

The present application claims priority to and the benefit of Korean Patent Application No. 10-2025-0042642, filed on Apr. 2, 2025, in the Korean Intellectual Property Office, the entire disclosure of which is incorporated herein by reference.

### BACKGROUND

### 1. Field

The present disclosure relates to a secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

Aspects of the present disclosure provide a secondary battery having a structure in which a jelly roll-type electrode assembly and a stack-type electrode assembly are disposed within one case.

Other aspects of the present disclosure provide a secondary battery in which an arrangement of a stack-type electrode assembly and a jelly roll-type electrode assembly provides maximized internal space so that high energy density is provided while maintaining mechanical stability of the electrode assembly.

However, the technical problems to be achieved in the embodiment of the disclosure are not limited to the technical problems mentioned above, and other technical problems not mentioned herein will be clearly understood from the following description by those skilled in the art to which the disclosure belongs.

According to some embodiments, a secondary battery includes: a wound electrode part including a first electrode plate, a second electrode plate, and a separator; and a plate-shaped electrode part provided to at least one side of the wound electrode part or in a core of the wound electrode part, the plate-shaped electrode part including a plate-shaped electrode plate.

In some embodiments, the plate-shaped electrode part may include: a first plate electrode part provided to a first side of the wound electrode part, the first plate electrode part including a stack of a positive electrode plate, a negative electrode plate, and a separator; and a second plate electrode part provided to a second side of the wound electrode part, the second plate electrode part including a stack of a positive electrode plate, a negative electrode plate, and a separator.

In some embodiments, the first plate electrode part, the wound electrode part, and the second plate electrode part may be sequentially stacked.

In some embodiments, the plate-shaped electrode part may include a core plate electrode part disposed in the core of the wound electrode part.

In some embodiments, the plate-shaped electrode part may include a core plate electrode part that is disposed in the core of the wound electrode part, the plate-shaped electrode part including a stack of a positive electrode plate, a negative electrode plate, and a separator.

In some embodiments, the positive electrode plate is electrically connected to a positive electrode terminal, and the positive electrode terminal is electrically connected to a first terminal that is connected to the first electrode plate of the wound electrode part, and the negative electrode plate is electrically connected to a negative electrode terminal, and the negative electrode terminal is connected to a second terminal connected to the second electrode plate of the wound electrode part.

In some embodiments, each of the first terminal and the second terminal may be provided in plurality.

In some embodiments, the plate-shaped electrode part may include: a first plate electrode part provided on a first side of the wound electrode part, the first plate electrode part including a stack of a positive electrode plate, a negative electrode plate, and a separator; a second plate electrode part provided to a second side of the wound electrode part, the second plate electrode part including a stack of a positive electrode plate, a negative electrode plate, and a separator; and a core plate electrode part between the first plate electrode part and the second plate electrode part, the core plate electrode part being provided in the core of the wound electrode part with the core plate electrode part including a stack of a positive electrode plate, a negative electrode plate, and a separator.

According to some embodiments, a secondary battery includes: a wound electrode part including a first electrode plate, a second electrode plate, and a separator; a plate-shaped electrode part provided to at least one side of the wound electrode part, or in a core of the wound electrode part, the plate-shaped electrode part including a plate-shaped electrode plate; and a case in which the winding electrode part and the plate-shaped electrode part are accommodated.

In some embodiments, the case may be a pouch and seals the wound electrode part and the plate-shaped electrode part.

In some embodiments, the plate-shaped electrode part may include a first plate electrode part provided to a first side of the wound electrode part, the first plate electrode part including a stack of a positive electrode plate, a negative electrode plate, and a separator; and a second plate electrode part provided to a second side of the wound electrode part, the second plate electrode part including a stack of a positive electrode plate, a negative electrode plate, and a separator.

In some embodiments, the first plate electrode part may be disposed between the case and the wound electrode part.

In some embodiments, the second plate electrode part may be disposed between the case and the wound electrode part.

In some embodiments, the first plate electrode part, the wound electrode part, and the second plate electrode part may be stacked.

In some embodiments, the plate-shaped electrode part may include a core plate electrode part disposed on the core of the wound electrode part.

In some embodiments, the plate-shaped electrode part may include a core plate electrode part that is disposed in the core of the wound electrode part, the plate-shaped electrode part including a stack of a positive electrode plate, a negative electrode plate, and a separator.

In some embodiments, the plate-shaped electrode part may include a first plate electrode part provided on a first side of the wound electrode part, the first plate electrode part including a stack of a positive electrode plate, a negative electrode plate, and a separator; a second plate electrode part provided to a second side of the wound electrode part, the second plate electrode part including a stack of a positive electrode plate, a negative electrode plate, and a separator; and a core plate electrode part between the first plate electrode part and the second plate electrode part, the core plate electrode part being provided in a core of the wound electrode part with the core plate electrode part including a stack of a positive electrode plate, a negative electrode plate, and a separator.

In some embodiments, the positive electrode plate may be electrically connected to a positive electrode terminal, and the positive electrode terminal may be electrically connected to a terminal connected to the first electrode plate of the wound electrode part.

In some embodiments, the negative electrode plate may be electrically connected to a negative electrode terminal, and the negative electrode terminal is electrically connected to a terminal connected to the second electrode plate of the wound electrode part.

In some embodiments, the core plate electrode part may be disposed between the first plate electrode part and the second plate electrode part in a stack.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a exploded perspective view of a secondary battery according to embodiments;

FIG. 2 is a perspective view of an electrode assembly according to embodiments;

FIG. 3 is a perspective view of the secondary battery according to embodiments;

FIG. 4 is a cross-sectional view of an electrode assembly according to embodiments;

FIG. 5 is a perspective view of a winding electrode part according to embodiments;

FIG. 6 is an exploded perspective view of a first plate electrode part according to embodiments;

FIG. 7 is an exploded perspective view of a second plate electrode part according to embodiments;

FIG. 8 is a perspective view of a core plate electrode part according to embodiments;

FIG. 9 is an exploded perspective view of a core plate electrode part according to other embodiments;

FIGS. 10 and 11 are perspective views of a battery pack including an exemplary secondary battery according to embodiments; and

FIGS. 12 and 13 are perspective and side views of a vehicle including an exemplary battery pack according to embodiments.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

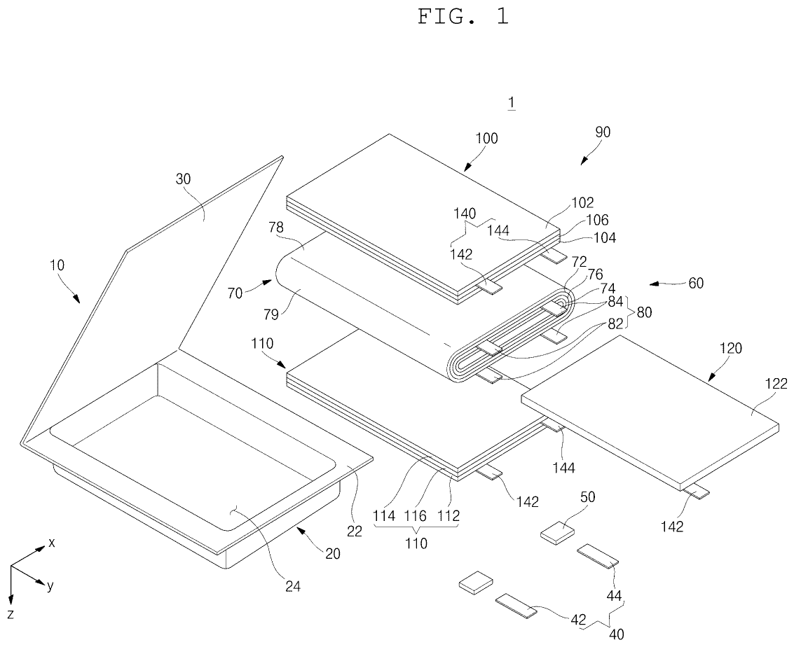

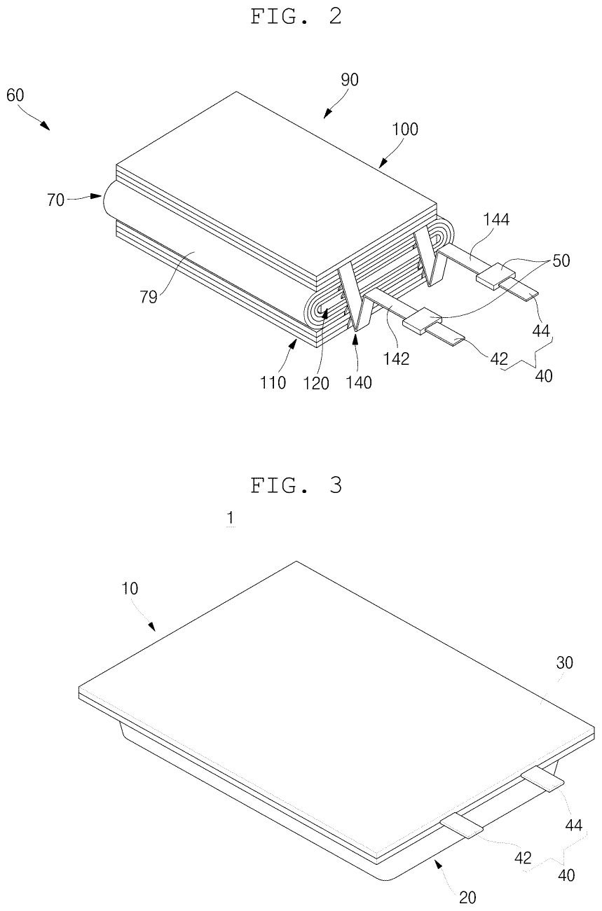

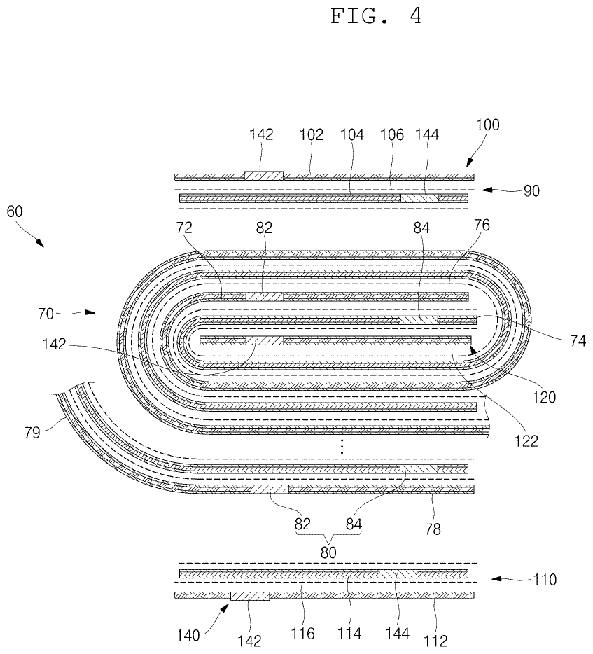

FIG. 1 is an exploded perspective view of a secondary battery 1 according to embodiments, FIG. 2 is a perspective view of an electrode assembly 60 according to embodiments, and FIG. 3 is a perspective view of the secondary battery 1 according to embodiments. As illustrated in FIGS. 1 to 3, the secondary battery 1 according to embodiments may include the electrode assembly 60 including a wound electrode part 70 and a plate electrode part 90. The secondary battery 1 further includes a case 10, an electrode lead 40, and an insulating tape.

In the present disclosure, as illustrated in FIG. 1, a longitudinal direction y is along a long side of the case 10, and a width direction x is along a short side of the case 10 that intersects perpendicularly with the longitudinal direction y. A vertical direction z is a direction that intersects perpendicularly with the length direction y and the width direction x. Based on the wound electrode part 70, an upward direction of the winding electrode part 70 is a first direction, and a downward direction of the wound electrode part 70 is a second direction.

The present disclosure relates to the secondary battery 1 with a structure of the electrode assembly 60 of the secondary battery 1 such that a jelly roll-type electrode assembly 60 and a stack-type electrode assembly 60 are used together within one case 10. As a result, the secondary battery 1 is provided with the advantages of each type of electrode assembly may be maximized, and disadvantages of each type of electrode assembly may be minimized. Also, mechanical stability and high energy density of the battery may be achieved.

The jelly roll-type electrode assembly 60 may have excellent mechanical robustness due in winding method. But such an electrode assembly 60 may have limitations with respect to space utilization if used alone. The stack-type electrode assembly 60 may provide high energy density, but such an electrode assembly 60 may have limitations considering the complexity in manufacturing process and deterioration in structural stability.

To solve these limitations, an object of the present disclosure is to provide a secondary battery in which the jelly roll-type electrode assembly (the winding electrode part 70) and the stack-type electrode assembly (the plate electrode part 90) are disposed within one case 10 to improve both performance and manufacturing processability of the battery.

According to embodiments, a structure in which the wound electrode part 70 and the plate electrode part 90 are disposed to be stacked, or the plate electrode part 90 is disposed inside a core of the wound electrode part 70, may be applied. Thus, more active materials may be contained in the same volume, and electrical connection between the electrodes may be such to minimize the internal resistance.

Because of these structural features, the secondary battery 1 according to the present disclosure may provide stable and high efficiency in applications that require high output performance (e.g., electric vehicles (EVs), energy storage systems (ESS), high-output industrial batteries, etc.), and may be applied the pouch-type secondary battery 1, which can be used in various battery products.

The case 10 may be designed to accommodate the wound electrode part 70 and the plate electrode part 90, which constitute the electrode assembly 60, and various modifications are possible to the case 10. The case 10 may be provided as the pouch-type to seal and accommodate the wound electrode part 70 and the plate electrode part 90.

The case 10 may use a pouch made of a soft film, and a rectangular film extending in the longitudinal direction y may be folded to provide a case body 20 and a case cover 30. After the electrode assembly 60 is accommodated in a recess 24 provided in the case body 20, the case cover 30 may rotate to be sealed in a manner in which an opened inlet of the case body 20 shielded.

In embodiments of the present disclosure, the pouch is not limited to an integrated structure in which the case body 20 and the case cover 30 are provided on a single film; rather, the case body 10 may be implemented in various other manners such as a can-type case 10. However, an example in which the case body 20 and the case cover 30 are formed from one rectangular film will be described below.

The case body 20 may include the recess 24 and a sealing part 22. The electrode assembly 60 is accommodated at approximate center of the recess 24, and the sealing part 22 may extend outward from three sides of the recess 24.

The sealing part 22 may be a surface that is parallel to and coupled to the case cover 30. For example, if the case body 20 and the case cover 30 are provided as separate members, the sealing part 22 may extend outward from the four sides of the recess 24. In embodiments where the case body 20 and the case cover 30 are integrated with each other, the sealing part 23 may extend outward from the four sides of the recess 24.

The case cover 30 and the case body 20 may be formed from a multilayer thin film including a metal thin film and insulating layers, which are disposed on first and second sides of the metal thin film. The case cover 30 and the case body 20 may define surfaces that are in contact with each other as inner surfaces and opposite surfaces as outer surfaces.

The recess 24 of the case body 20 may sized to accommodate the electrode assembly 60 through pressing, drawing processing, etc. In the case body 20, an edge of the recess 24 and an edge of the case cover 30 may be thermally fused to each other after the case cover 30 covers the portion in which the recess 24 is defined. The pouch may be sealed by sealing an edge area of the case body 20 and an edge area of the case cover 30 after the electrode assembly 60 is accommodated in the recess 24.

The edge of the case body 20 disposed on the outer side of a plane with respect to the recess 24 that is sealed with the edge of the case cover 30 may be defined as the sealing part 22. An inner surface of the pouch may have a thermal fusion layer made of a thermal fusion material.

The case cover 30 may have a rectangular flat shape. The case cover 30 may be connected to the case body 20 to cover an upper portion of the case body 20 by a folding operation. The case cover 30 may be modified in various manners, such as by defining a groove for accommodating the electrode assembly 60 together with the case body 20.

The electrode lead 40 may electrically connect the electrode assembly 60 to an external circuit and may be made of a conductive material that allows current to flow smoothly. An inner side of the electrode lead 40 may be electrically connected to a wound electrode terminal 80 and a plate electrode terminal 140 of the electrode assembly 60. The outer side of the electrode lead 40 may extend to outside of the case body 20 by passing through the case 10.

The electrode lead 40 may be constituted by a positive electrode lead 42 and a negative electrode lead 44. The positive electrode lead 42 may be electrically connected to a first terminal 82 of the wound electrode part 70 and a positive electrode terminal 142 of the plate electrode part 90. The negative electrode lead 44 may be electrically connected to a second terminal 84 of the wound electrode part 70 and the negative electrode terminal 144 of the plate electrode part 90.

In some embodiments, the electrode lead 40 may be made of copper (Cu), aluminum (Al) or a conductive alloy in consideration of current capacity, electrical contact resistance, mechanical strength, etc. In some embodiments, the electrode lead 40 may have a nickel (Ni), tin (Sn) or other corrosion-resistant plating layer on a surface thereof to enhance durability.

The electrode lead 40 may be provided in various shapes (e.g., flat type, round type, ribbon type, etc.) depending on the arrangement of the electrode assembly 60 and the design of the battery. The electrode lead 40 may have a single-layer or multi-layer structure.

The insulating tape 50 may provide electrical insulation between the electrode lead 40 and the case 10 to protect the electrode lead 40 from external environments. The insulating tape 50 may be provided on each of both side surfaces of the electrode lead 40 that is in contact with the case 10 to prevent electrical short-circuit from occurring due to the electrode lead 40 that is in direct contact with the case 10.

The insulating tape 50 may be, for example, made of polyimide (PI), polypropylene (PP), polyethylene (PE) or other materials with excellent insulating properties. In some embodiments, the insulating tape 50 may include a ceramic coating layer to enhance heat resistance and chemical resistance.

The insulating tape 50 may include an adhesive layer for fixing and sealing the electrode lead 40 and may be designed to facilitate positional alignment during a battery assembly process. An additional protective layer (e.g., a silicone coating layer) may be disposed between the electrode lead 40 and the insulating tape 50 to protect against mechanical shock or environmental changes.

The electrode assembly 60 may include the wound electrode part 70 and the plate electrode part 90. The wound electrode part 70 may be provided in a wound shape (jelly roll-type), and the plate electrode part 90 may be provided in a laminated shape (stack shape).

The wound electrode part 70 may have a multi-layered structure including a first electrode plate 72, a second electrode plate 74, and a separator 76.

The plate electrode part 90 may be provided in a stack structure in which a positive electrode plate 102, a negative electrode plate 104, and a separator 106 are alternately stacked. The plate electrode part 90 may be electrically connected to the wound electrode part 70 to enhance power density and charge/discharge characteristics of the battery.

The plate electrode part 90 may be disposed above or below the wound electrode part 70 or on a core of the wound electrode part 70. As such, the structural stability and performance of the electrode assembly 60 may be adjusted depending on the arrangement of the plate electrode part 90 and the wound electrode part 70.

In some embodiments, a conductive adhesive, welding (ultrasonic or laser welding), or other conductive bonding techniques maybe used in the electrode assembly 60 to minimize the electrical resistance between the winding electrode part 70 and the plate electrode part 90.

Each of the first electrode plate 72 and the second electrode plate 74 provided in the wound electrode part 70 may be electrically connected to the wound electrode terminal 80 and, thus, current can be transmitted to outside through the first electrode plate 72 and the second electrode plate 74. The first electrode plate 72 may be electrically connected to the first terminal 82, and the second electrode plate 74 may be electrically connected to the second terminal 84.

Depending on the structural characteristics of the wound electrode part 70, the first terminal 82 and the second terminal 84 may be provided as a single terminal or multiple terminals. If provided the first and second terminals 82 and 84 are provided in plurality, a current dissipation effect may be improved.

The wound electrode terminal 80 may include a heat dissipation structure (e.g., application of nickel plating, an aluminum alloy, etc.) to minimize heat generation if high current is applied. In some embodiments, the electrode terminal may include surface treatment (e.g., tin plating, nickel plating, silver plating, etc.) to reduce contact resistance with external terminals.

The plate electrode part 90 may be electrically connected to the plate electrode terminal 140 to transmit current within the electrode assembly 60. The plate electrode terminal 140 may be constituted by the positive electrode terminal 142 and the negative electrode terminal 144.

The positive electrode plate 102 of the first plate electrode part 100 may be electrically connected to the positive electrode terminal 142, and the positive electrode plate 102 of the second plate electrode part 110 may also be connected to the positive electrode terminal 142. The negative plate 104 of the first plate electrode part 100 may be electrically connected to the negative electrode terminal 144, and the negative plate 104 of the second plate electrode part 110 may also be connected to the negative electrode terminal 144. If the electrode plate 122 provided in the core plate electrode part 120 functions as a positive electrode, the electrode plate 122 may be electrically connected to the positive electrode terminal 142. The plate electrode terminal 140 may be designed to maintain a uniform current flow within the secondary battery 1 through the electrical connection with the wound electrode part 70.

The positive electrode terminal 142 connected to the positive electrode plate 102 may be electrically connected to the first terminal 82 connected to the first electrode plate 72 of the wound electrode part 70. The negative electrode terminal 144 connected to the negative plate 104 may be electrically connected to the second terminal 84 connected to the second electrode plate 74 of the wound electrode part 70. With this configuration, the wound electrode part 70 and the plate electrode part 90 may be electrically connected. Thus, the internal resistance of the battery may be minimized and uniform current distribution may be provided.

In some embodiments, the plate electrode terminal 140 may be made of a conductive metal (e.g., nickel (Ni), aluminum (Al), copper (Cu)), and tin (Sn)) and/or nickel plating may be applied to a surface to reduce electrical contact resistance. The electrode terminal may be bonded to the electrode plate 122 using, for example, ultrasonic welding, laser welding, or a conductive adhesive, thereby ensuring the high mechanical stability and durability.

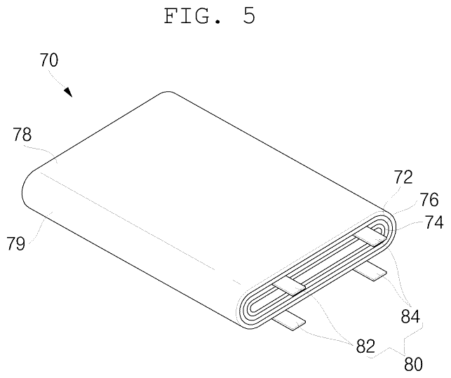

FIG. 4 is a cross-sectional view of the electrode assembly 60 according to embodiments. As illustrated in FIG. 4, the electrode assembly 60 may include the wound electrode part 70 and the plate electrode part 90, with the wound electrode part 70 and the plate electrode part 90 being electrically connected.

If an upper side of the wound electrode part 70 is defined as a first direction, and a lower side of the wound electrode part 70 is defined as a second direction, the plate electrode parts 90 may be installed in the first and second directions (i.e., above and below) of the wound electrode part 70, respectively. In some embodiments, he plate electrode part 90 may be provided only in the first direction of the wound electrode part 70, or the plate electrode part 90 may be provided only in the second direction of the wound electrode part 70. The plate electrode part 90 may also be provided on the core of the wound electrode part 70.

The wound electrode part 70 may have a jelly roll-type structure in which a first electrode plate 72, a second electrode plate 74, and a separator 76 are wound. The plate electrode part 90 may have a stack-type structure in which a positive electrode plate 102, a negative electrode plate 104, and a separator 106 are stacked.

Depending on the arrangement of the wound electrode part 70, the plate electrode part 90 may be disposed in the first direction (upper side), the second direction (lower side) of the wound electrode part 70 or on the core of the wound electrode part 70. The plate electrode part 90 may be provided to the upper side (first direction) and lower side (second direction) of the wound electrode part 70. In some embodiments, the plate electrode part 90 may be disposed only in a specific direction (e.g., upper or lower side) of the wound electrode part 70. In other embodiments, the plate electrode part 90 may be disposed inside the core of the wound electrode part 70 to improve electrical connectivity and structural stability of the electrode assembly 60.

The plate electrode part 90 may include at least one of the first plate electrode part 100, the second plate electrode part 110, or the core plate electrode part 120. The first plate electrode part 100, the winding electrode part 70, and the second plate electrode part 110 may be stacked sequentially. The core plate electrode part 120 may be provided in the core of the wound electrode part 70 disposed between the first plate electrode part 100 and the second plate electrode part 110. With such a configuration, the electrode assembly 60 may include both the robust structural characteristics of the jelly roll-type electrode assembly 60 and the high energy density characteristics of the stack-type electrode assembly 60 to thereby maximize utilization of the internal space of a secondary battery.

In some embodiments, ultrasonic welding, laser welding, conductive adhesive, or other electrical bonding techniques may be used to optimize the electrical connection between the winding electrode part 70 and the plate electrode part 90.

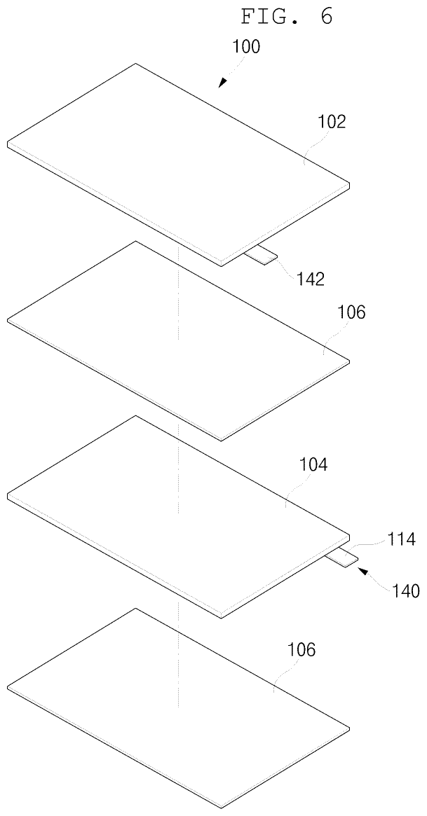

FIG. 5 is a perspective view of the wound electrode part according to embodiments. As illustrated in FIG. 1 and FIG. 5, the wound electrode part 70 may be modified in various ways while having the first electrode plate 72, the second electrode plate 74, and the separator 76. The core plate electrode part 120 may be provided in a space of the core of the wound electrode part 70. The core plate electrode part 120 may be mounted on the core of the wound electrode part 70 in a sliding manner.

The wound electrode part 70 may include a first electrode plate 72, a second electrode plate 74, and a separator 76. In some embodiments, the wound electrode part 70 may be provided in the form of a roll in which the negative electrode part, the positive electrode part, and the separator 76 are wound.

More specifically, the wound electrode part 70 may be provided with the first electrode plate 72 accommodated in the case 10, the second electrode plate 74, and the separator 76 disposed between the first electrode plate 72 and the second electrode plate 74 to provide the winding electrode terminal 80 in one direction. In the present disclosure, the case 10 may be referred to as a pouch.

The wound electrode part 70 may be accommodated inside the pouch together with an electrolyte. The electrolyte may be provided as a combination of an organic solvent and a lithium salt. The organic solvent may include ethylene carbonate (EC), propylene carbonate (PC), diethyl carbonate (DEC), ethyl methyl carbonate (EMC), and dimethyl carbonate (DMC). But the present disclosure is not limited to these examples. Lithium salts such as lithium hexafluorophosphate (LiPF₆) or lithium tetrafluoroborate (LiBF₄) may be used, and the electrolyte may be provided as an appropriate composition in consideration of electrical and chemical reactivity with the electrode.

The first electrode plate 72 may be a plate-shaped current collector made of aluminum (Al), support an electrode active material, and provide electrical conduction. Both surfaces of the first electrode plate 72 may be coated with a positive electrode active material that is a transition metal oxide. In some embodiments, an area where the positive electrode active material is not provided (positive electrode non-coated portion) may be at one side of the first electrode plate 72, and the positive electrode non-coating portion may be used as an electrode terminal connection part and a bonding area.

The first electrode plate 72 may have a surface that is oxidized or is provided with an added protective coating to provide mechanical stability and electrical characteristics of the electrode. To increase in adhesion of the electrode, surface treatment (e.g., aluminum oxide treatment, conductive coating, etc.) that improves interfacial adhesion with the positive electrode active material may be applied to the electrode plate 72.

The second electrode plate 74 may be disposed at a position corresponding to that of the first electrode plate 72 and may act as a current collector supporting the negative electrode active material. The second electrode plate 74 may be a plate structure made of copper (Cu) or nickel (Ni) and may be coated with a graphite or carbon-based negative electrode active material on its surfaces.

An area on the second electrode plate 74 where a negative electrode active material is not applied (negative electrode non-coated portion) may be provided at a side of the second electrode plate 74, and the negative electrode non-coating portion may be used for electrical connection and welding to the electrode terminal. In some embodiments, the second electrode plate 74 may include surface treatment (e.g., nickel plating, anti-oxidation coating, etc.) to minimize the internal resistance and improve the adhesion to the negative electrode active material.

The separator 76 may be disposed between the first electrode plate 72 and the second electrode plate 74 to prevent direct contact between the electrodes and only allow the movement of ions. The separator 76 may be made from polyethylene (PE), polypropylene (PP), or a multilayer composite film thereof.

In some embodiments a ceramic coating layer (e.g., Al₂O₃, SiO₂, TiO₂, etc.) may be added to improve thermal stability. Further, a hydrophilic coating layer (e.g., a polyvinylidene fluoride (PVDF)-based coating) may be applied to improve electrolyte retention capacity. The separator 76 may have a microporous structure to increase in adhesion to the electrode and may be designed as a multilayer structure.

The wound electrode part 70 may be provided with specific structural characteristics. Both sides of the wound electrode part 70 in the width direction x may have a curved surface, which is referred to as a round portion 79. Each of top and bottom surfaces of the winding electrode part 70 may have a flat surface 78 to maintain the structural stability of the electrode assembly 60 and improve bonding with the plate electrode part 90.

A first plate electrode part 100 may be provided on the flat surface 78 in the first direction, and a second plate electrode part 110 may be provided on the flat surface 78 in the second direction for utilization of the internal space of the electrode assembly 60.

As illustrated in FIGS. 1 and 2, the plate electrode part 90 may be disposed in at least one of the first direction (upper side) and the second direction (lower side) of the wound electrode part 70 or the core of the wound electrode part 70 and may have a structure including a plate-shaped electrode plate 122.

The plate electrode part 90 may be provided as the stack-type structure in which the positive electrode plate 102, the negative electrode plate 104, and the separator 106 are alternately stacked, to ensure the electrical connection within the electrode assembly 60 together with the winding electrode part 70 and improve the utilization of the internal space.

The plate electrode part 90 may include an insulating layer so as not to be in direct contact with the wound electrode part 70, and the separator 106 may be added to prevent short circuit between the electrodes from occurring. Depending on the arrangement method within the electrode assembly 60, the plate electrode part 90 may be designed as a single layer or multi-layer structure and may be deformed into various shapes to minimize internal resistance and optimize a current flow.

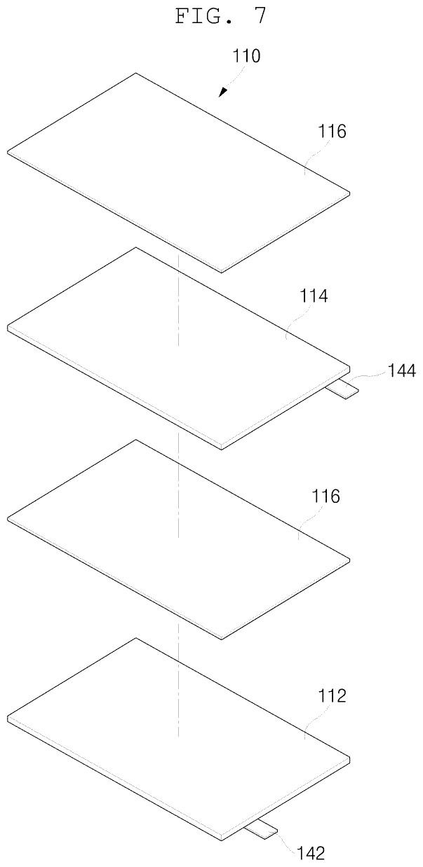

FIG. 6 illustrates an exploded perspective view of the first plate electrode part 100 according to embodiments. As illustrated in FIG. 6, the first plate electrode part 100 may be disposed in the first direction (upper side) of the wound electrode part 70 and may be provided in the stack-type structure in which the positive electrode plate 102, the negative electrode plate 104, and the separator 106 are stacked in a plate shape.

The first plate electrode part 100 may be disposed between the case 10 and the wound electrode part 70 and may be electrically connected to the wound electrode part 70 within the electrode assembly 60 to provide for performance of the battery.

Although the positive electrode plate 102, the negative electrode plate 104, and the separator 106 are stacked in the plate shape in the plate electrode part 90, the positive electrode plate 102 may be made of a material that is the same as or similar to that of the first electrode plate 72 of the wound electrode part 70. Further, the negative electrode plate 104 may be made of a material that is the same as or similar to that of the second electrode plate 74 of the wound electrode part 70. And the separator 106 may also perform the same or similar function as the separator 76 of the wound electrode part 70. Thus, because the specific material and function of the first plate electrode part 100 are similar to those of the configuration of the wound electrode part 70 described above, further descriptions thereof will be omitted.

The first plate electrode part 100 may be modified in various ways depending on the number and shape of the positive and negative plates 102 and 104. The positive, the negative plates 104, and the separator 106, may be configured to maximize the utilization of the internal space of the electrode assembly 60. For example, the arrangement of the electrode terminals may be adjusted to reduce the internal resistance, or the bonding may be performed using the conductive adhesive or the welding techniques.

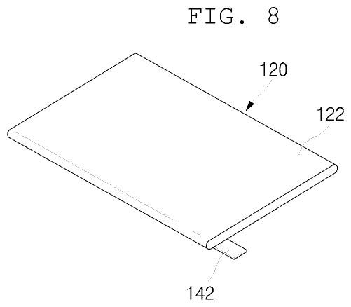

FIG. 7 is an exploded perspective view of the second plate electrode part 110 according to embodiments. As illustrated in FIG. 1 and FIG. 7, the second plate electrode part 110 may be disposed in the second direction (lower side) of the wound electrode part 70 and may have the stack-type structure in which the positive electrode plate 112, the negative electrode plate 114, and the separator 116 of the second plate electrode part 110 are stacked in the plate shape.

The second plate electrode part 110 may be disposed between the case 10 and the wound electrode part 70 and may be electrically connected to the winding electrode part 70 within the electrode assembly 60 to provide for the performance of the battery.

The first plate electrode part 100 and the second plate electrode part 110 may be provided in the same shape and may be disposed to face each other with respect to the wound electrode part 70. In some embodiments, the first plate electrode part 100 and the second plate electrode part 110 may be symmetrically disposed around the wound electrode part 70. In other embodiments, a gap between the first plate electrode part 100 and the second plate electrode part 110 may be adjusted to provide for internal current flow. In addition, the first plate electrode part 100 and the second plate electrode part 110 may be electrically connected to provide the electrical connection with the wound electrode part 70, thereby reducing the internal resistance and improving charging and discharging efficiency. Ultrasonic welding, laser welding, and/or conductive adhesives may be used as the electrical connection methods, and the structural stability and the durability may be enhanced depending on the bonding method.

Because the configuration of the second plate electrode part 110 is similar or the same as that of the first plate electrode part 100, detailed descriptions thereof will be omitted. However, the number of layers of the second plate electrode part 110, a gap between the electrodes, a thickness of the separator 116, etc., may be adjusted according to the arrangement of the electrode assembly 60.

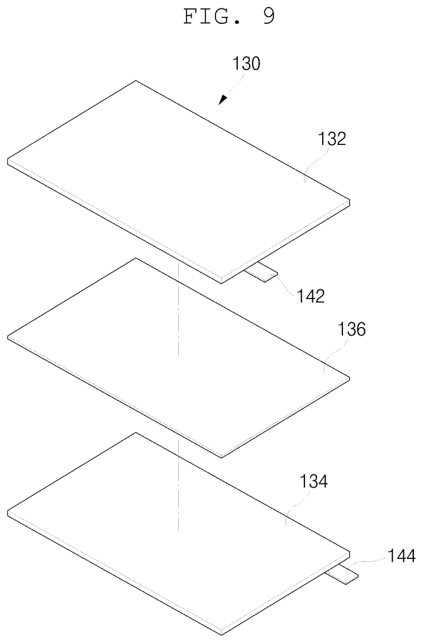

FIG. 8 is a perspective view of the core plate electrode part 120 according to embodiments. As illustrated in FIG. 1 and FIG. 8, the core plate electrode part 120 may be disposed in the core of the wound electrode part 70 and may include a structure in which the electrode plate 122 is provided in the plate shape. The core plate electrode part 120 may be provided as an electrode plate 122 having a single polarity.

In some embodiments, only one electrode plate 122 of either the positive or negative electrode may be provided. In other embodiments, the positive and negative electrode plates 122 may be stacked in a plurality of layers as necessary to provide for the electrical performance and capacity of the electrode assembly 60.

The core plate electrode part 120 may be disposed between the first plate electrode part 100 and the second plate electrode part 110 to supplement the electrical connection with the wound electrode part 70 and provide for the internal current flow. Conductive adhesive, ultrasonic welding, and/or the laser welding may be used to provide the electrical connection between the core plate electrode part 120 and the wound electrode part 70.

The first plate electrode part 100, the second plate electrode part 110, and the core plate electrode part 120 may be provided in the stack-type. The gap between the electrode parts may be adjusted to minimize the internal resistance and provide for charge/discharge balance.

A thickness, a stacking method, and a material composition of the core plate electrode part 120 may be modified according to performance requirements of the battery. In some embodiments, the core plate electrode part 120 may include an insulating layer so as to be stably fixed inside the wound electrode part 70. Insulating coating may be applied to prevent direct electrical contact with the wound electrode part 70. In some embodiments, the electrode plate 122 of the core plate electrode part 120 may be disposed together with the separator 76 to prevent the short-circuit between the electrodes.

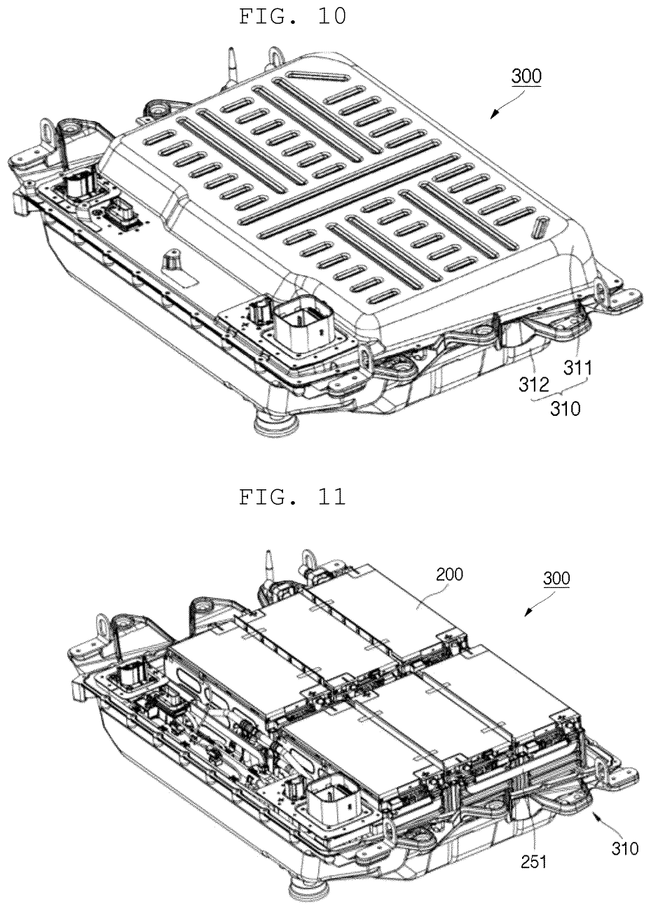

FIG. 9 illustrates an exploded perspective view of a core plate electrode part 130 according to further embodiments. As illustrated in FIG. 9, a core plate electrode part 130 may be disposed on a core of a wound electrode part 70 and may have a stack structure in which a positive electrode plate 132, a negative electrode plate 134, and a separator 136 are stacked in a plate shape. The core plate electrode part 130 may be disposed between a first plate electrode part 100 and a second plate electrode part 110 and may be designed to be electrically connected to the winding electrode part 70.

In other embodiments, an arrangement direction and the electrical connection method of the core plate electrode part 130 may be made to maintain the uniform current flow within the electrode assembly 60 and minimize the internal resistance.

The core plate electrode part 130 may be provided as a structure in which the positive electrode plate 132 and the negative electrode plate 134 are stacked with the separator 136 therebetween, and each of the positive electrode plate 132 and the negative electrode plate 134 may be formed from a material that is the same as or similar to that of the electrode plate 122 of the winding electrode part 70. The separator 136 may be made of a material that is the same as or similar to that of the separator 76 used in the winding electrode part 70 and may function to prevent short circuit between the electrodes.

In consideration of reactivity with an electrolyte, a protective coating layer may be added to a surface of the electrode plate 122 of the core plate electrode part 130. In some embodiments, conductive adhesive, ultrasonic welding or laser welding may be applied to strengthen the electrical connection of the core plate electrode part 130.

An insulating layer or protective film may be added to ensure physical stability within the electrode assembly 60. To increase in structural rigidity of the electrode assembly 60, the core plate electrode part 130 may be fixed inside a housing or frame. The arrangement method of the core plate electrode part 130 may vary depending on the design of the battery and the required electrical characteristics, and the improved performance may be achieved by adjusting the number of layers, a gap between the electrodes, an electrolyte penetration rate, etc.

The electrode assembly 60 according to the present disclosure will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt. % to about 99.5 wt. % on the basis of 100 wt. % of the positive electrode active material layer, and the content of the binder and the conductive material is in a range of about 0.5 wt. % to about 5 wt. %, respectively, on the basis of 100 wt. % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt. % to about 99 wt. % of a negative electrode active material, about 0.5 wt. % to about 5 wt. % of a binder, and about 0 wt. % to about 5 wt. % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

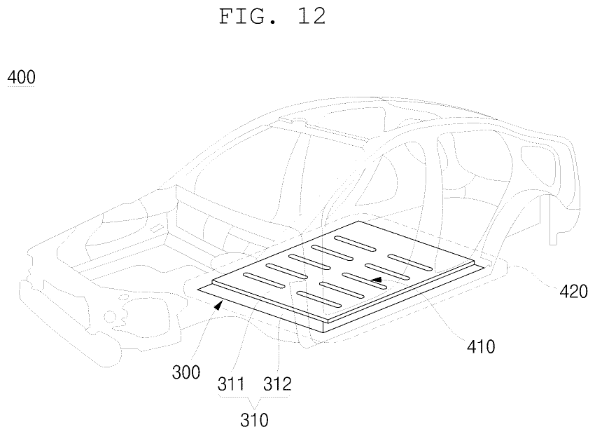

The batteries according to the above-described embodiments may be used to manufacture a battery pack. FIGS. 10 and 11 are perspective views showing a battery pack including the exemplary secondary battery according to the present disclosure. Referring to FIGS. 10 and 11, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

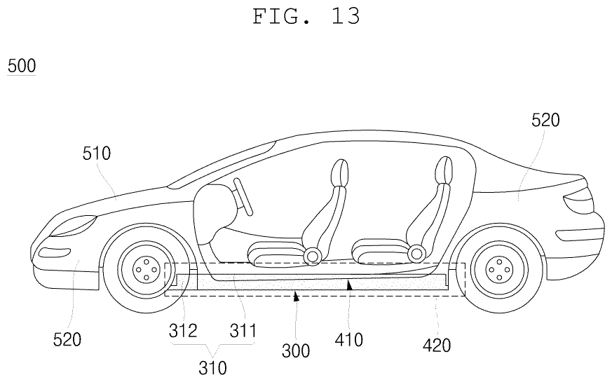

FIGS. 12 and 13 are, respectively, a perspective view and a side view showing vehicles 400 and 500 including the exemplary battery pack 300 according to the present disclosure.

In FIG. 12, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 13, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to the present disclosure, the jelly roll-type electrode assembly and the stack-type electrode assembly may be effectively disposed within one case to maximize the advantages and compensate for the disadvantages in each manner, thereby ensuring the high energy density while maintaining the structural stability of the electrode assembly.

According to the present disclosure, the arrangement of the stack-type electrode assembly and the jelly roll-type electrode assembly may be optimized to maximize the internal space utilization, and thus, more active materials may be contained in the same volume to improve the capacity and output characteristics of the battery.

According to the present disclosure, because the electrical connection between the electrode assemblies may be optimized to minimize the internal resistance, thereby reducing the power loss during the charging and discharging processes and enabling the efficient power supply even in the applications that require the high output performance.

According to the present disclosure, because of being applied to the pouch-type secondary battery using the soft film, it may be utilized in various forms of the battery products, and the secondary battery having the improved mechanical stability while maintaining the high energy density may be provided.

However, the effects achievable through the present invention are not limited to those described above, and other technical effects not mentioned can be clearly understood by those skilled in the art from the description of the invention provided above.

Although a few embodiments of the present disclosure have been shown and described, it would be appreciated by those skilled in the art that various changes and modifications may be made in this embodiment without departing from the principles and spirit of the disclosure.

What is claimed is

1. A secondary battery comprising:
a wound electrode part including a first electrode plate, a second electrode plate, and a separator; and
a plate-shaped electrode part provided to at least one side of the wound electrode part or in a core of the wound electrode part, the plate-shaped electrode part including a plate-shaped electrode plate.

2. The secondary battery as claimed in claim 1, wherein the plate-shaped electrode part comprises:
a first plate electrode part provided to a first side of the wound electrode part, the first plate electrode part including a stack of a positive electrode plate, a negative electrode plate, and a separator; and
a second plate electrode part provided to a second side of the wound electrode part, the second plate electrode part including a stack of a positive electrode plate, a negative electrode plate, and a separator.

3. The secondary battery as claimed in claim 2, wherein the first plate electrode part, the wound electrode part, and the second plate electrode part are sequentially stacked.

4. The secondary battery as claimed in claim 1, wherein the plate-shaped electrode part comprises a core plate electrode part disposed in the core of the would electrode part.

5. The secondary battery as claimed in claim 1, wherein the plate-shaped electrode part comprises a core plate electrode part that is disposed in the core of the wound electrode part, the plate-shaped electrode part including a stack of a positive electrode plate, a negative electrode plate, and a separator.

6. The secondary battery as claimed in claim 5, wherein the positive electrode plate is electrically connected to a positive electrode terminal, and the positive electrode terminal is electrically connected to a first terminal that is connected to the first electrode plate of the wound electrode part, and
wherein the negative electrode plate is electrically connected to a negative electrode terminal, and the negative electrode terminal is connected to a second terminal connected to the second electrode plate of the wound electrode part.

7. The secondary battery as claimed in claim 6, wherein each of the first terminal and the second terminal are provided in plurality.

8. The secondary battery as claimed in claim 1, wherein the plate-shaped electrode part comprises:
a first plate electrode part provided on a first side of the wound electrode part, the first plate electrode part including a stack of a positive electrode plate, a negative electrode plate, and a separator;
a second plate electrode part provided to a second side of the wound electrode part, the second plate electrode part including a stack of a positive electrode plate, a negative electrode plate, and a separator; and
a core plate electrode part between the first plate electrode part and the second plate electrode part, the core plate electrode part being provided in the core of the wound electrode part with the core plate electrode part including a stack of a positive electrode plate, a negative electrode plate, and a separator.

9. A secondary battery comprising:
a wound electrode part including a first electrode plate, a second electrode plate, and a separator;
a plate-shaped electrode part provided to at least one side of the wound electrode part or in a core of the wound electrode part, the plate-shaped electrode part including a plate-shaped electrode plate; and
a case in which the wound electrode part and the plate-shaped electrode part are accommodated.

10. The secondary battery as claimed in claim 9, wherein the case is a pouch and seals the wound electrode part and the plate-shaped electrode part.

11. The secondary battery as claimed in claim 9, wherein the plate-shaped electrode part comprises:
a first plate electrode part provided to a first side of the wound electrode part, the first plate electrode part including a stack of a positive electrode plate, a negative electrode plate, and a separator; and
a second plate electrode part provided to a second side of the wound electrode part, the second plate electrode part including a stack of a positive electrode plate, a negative electrode plate, and a separator.

12. The secondary battery as claimed in claim 11, wherein the first plate electrode part is disposed between the case and the wound electrode part.

13. The secondary battery as claimed in claim 11, wherein the second plate electrode part is disposed between the case and the wound electrode part.

14. The secondary battery as claimed in claim 11, wherein the first plate electrode part, the wound electrode part, and the second plate electrode part are stacked.

15. The secondary battery as claimed in claim 9, wherein the plate-shaped electrode part comprises a core plate electrode part disposed in the core of the wound electrode part.

16. The secondary battery as claimed in claim 9, wherein the plate-shaped electrode part comprises a core plate electrode part that is disposed in the core of the wound electrode part, the plate-shaped electrode part including a stack of a positive electrode plate, a negative electrode plate, and a separator.

17. The secondary battery as claimed in claim 9, wherein the plate-shaped electrode part comprises:
a first plate electrode part provided on a first side of the wound electrode part, the first plate electrode part including a stack of a positive electrode plate, a negative electrode plate, and a separator;
a second plate electrode part provided to a second side of the wound electrode part, the second plate electrode part including a stack of a positive electrode plate, a negative electrode plate, and a separator; and
a core plate electrode part between the first plate electrode part and the second plate electrode part, the core plate electrode part being provided in a core of the wound electrode part with the core plate electrode part including a stack of a positive electrode plate, a negative electrode plate, and a separator.

18. The secondary battery as claimed in claim 17, wherein the positive electrode plate is electrically connected to a positive electrode terminal, and the positive electrode terminal is electrically connected to a terminal connected to the first electrode plate of the wound electrode part.

19. The secondary battery as claimed in claim 17, wherein the negative electrode plate is electrically connected to a negative electrode terminal, and the negative electrode terminal is electrically connected to a terminal connected to the second electrode plate of the wound electrode part.

20. The secondary battery as claimed in claim 17, wherein the core plate electrode part is disposed between the first plate electrode part and the second plate electrode part in a stack.
